(19) United States
(12) Patent Application Publication
(10) Pub. No.: US 2010/0084883 A1
(43) Pub. Date: Apr. 8, 2010

(54) Vehicle Console Organizer

(76) Inventor: Stephen MacDonald, West Palm Beach, FL (US)

Correspondence Address: MCHALE & SLAVIN, P.A., 2855 PGA BLVD, PALM BEACH GARDENS, FL, 33410, US

(21) Appl. No.: 12/246,105

(22) Filed: Oct. 6, 2008

(51) Int. Cl. B60J 9/00

(52) U.S. Cl. 296/1.07

(57) ABSTRACT

A device for use in conjunction with a console on a seat in a vehicle. The device enables an individual to maintain an office for business within a vehicle, such as a truck. The device includes a base unit which surrounds the console and is equipped with compartments, receptacles, writing surfaces and devices to support and retain electronic devices, such as lap top computers. The device includes a base unit. A plurality of writing surfaces and other compartments can be removable secured to the base unit. The writing surfaces can be provided with additional supports which are secured to the undersurface of the writing surface. The additional supports are designed to contact the seat of a vehicle and provide additional support for the writing surface. A compartment which is adapted to retain items such as cell phones, pagers and beverage vessels is releasably secured to a front of the base unit. A compartment which is adapted to retain items such as hanging files and beverage vessels is releasably secured to a rear of the base unit. A device to removably support an electronic device, such as a lap top computer, can be secured to the device. A strap extends from one of the sides of the base unit to the other side across the bottom of the base unit. The strap is used to help secure the device to a center console of a vehicle.

### FIELD OF THE INVENTION

The present invention generally relates to a device which can be placed on the seat of a vehicle and used by an occupant of the vehicle to perform work on and also for storage. More particularly, the present invention relates to a device which can be placed around a console or storage structure which is located in the center of the front seat of a vehicle. The present invention can provide a work surface in the form of a desk, a surface to support a lap top computer, storage for items, etc.

### BACKGROUND OF THE INVENTION

Many individuals conduct business in their vehicles. In particular tradespersons who provide their services at an individual's home or place of business will usually first come to the individual's home or business and give that individual an estimate. These tradesperson will try to schedule a number of estimates on a given day or after a job has been completed. In order for the tradesperson to give the customer a correct and accurate estimate they will need to have access to a writing surface, certain information books and sometimes the Internet. Currently access to all these is not available in a vehicle and in particular not in the front seat of a vehicle. Therefore there is a need for a device or structure which can be placed in the front seat of a vehicle, in particular a truck, and used to enable an individual in the front seat to conduct business. Currently many vehicles including trucks are provided with center console devices that are located in the front seat of a vehicle and function as a combination arm rest and storage device. In some instances a flat surface is provided on the top of the device which enables an individual to write on the center console. There are no provisions in the current consoles available in vehicles today which enable an individual to store and have ready access to cell phones, pagers, calculators, PDAs, laptop computers, information manuals, product manuals, etc.

### DESCRIPTION OF THE PRIOR ART

U.S. Published Patent Application No. 2005/0035618 filed by Toth et al., discloses a storage console, including mix and match storage modules which can be arranged in a variety of positions on a supporting framework. The modules include end or terminal bins, lateral bins, medial bins, wall panels, and cargo nets. The framework of the console includes a base tray supporting a plurality of upright members, each of the upright members has grooves of a predetermined cross-section whereby a user can affix the desired modules to the storage console. Each module is adapted to provide flexibility and cooperate with different storage compartments. Wall panels may be attached to the framework to facilitate secure and private storage. In addition, provision can also be made for connecting different powered accessories such as lighting, audio, video, and the like. In addition the base of the center floor console along with said accessories may with the twist of a latch, be removed from the vehicle entirely. The console is designed to be secured to the floor of a vehicle, not placed around an existing console or structure.

U.S. Pat. No. 7,237,816 to Singh et al., discloses a center console for an automotive vehicle which includes an internal storage area accessible through an opening covered by a pivoted lid. The lid also serves as an armrest. The vertical front face of the console immediately forwardly of the armrest is open to create an access opening that is greater than the opening covered merely by the pivoted lid. A removable storage tray seated in the upper portion of the storage area covers the open vertical front face of the console. The opening of the pivoted lid and the removal of the storage tray creates an access opening into the storage area that will accommodate the insertion of a laptop computer or a purse for hidden storage within the internal storage area of the center console. This is a center console which is designed to be secured to the floor of a vehicle and not placed around an existing device on a seat of a vehicle.

U.S. Published Patent Application No. 2007/0138819 filed by Akimoto et al., discloses a console assembly positioned within the passenger compartment of an automobile. The console assembly includes: a console frame having at least a first tubular portion and a plurality of legs where each leg is supported on the vehicle frame; an outer shell connected to the console frame for use in covering the console frame; and, an armrest supported on the console frame and adapted to support a person's arm. The console is not designed or intended to fit over an existing console or structure on a seat of a vehicle.

U.S. Published Patent Application No. 2007/0046058 filed by Busha et al., discloses a removable storage console for a vehicle. The console includes a base and a body. The console also includes a handle on the outside of the body. A link member is connected to the handle. An upper housing is secured to a bottom portion of the body. A lower housing is secured to the upper housing. The console includes a plurality of latches arranged between the lower housing and the body member. The console is removable from and capable of being secured at multiple positions within the vehicle by securing a plurality of bases at different positions within the vehicle. The console is not designed or intended to fit over an existing console or structure on a seat of a vehicle.

U.S. Pat. No. 7,104,580 to Clark et al., discloses a low profile floor console for a vehicle includes a pair of end walls. In a lowered position, the console permits pass through between two spaced apart vehicle seats. When raised, fabric or netting attached, together with the end walls define a storage area. In the preferred embodiment, an add-on module fits over the raised end walls to provide a rigid storage area, and additional functionality, such as a tray, a power port, cup holders, change bins, and the like. The lid of the add-on module may be configured for sliding or pivotal movement to allow access to the interior thereof. Also in the preferred embodiment, the floor console is constructed to trim out a parking brake assembly. In other alternate embodiments, the floor console end walls may be constructed to provide additional functionality, such as internal map pockets, and the console system may be arranged for use at different locations within the vehicle, such as in the cargo area. The add-on console modules may additionally provide a variety of functionality besides storage, such as a cooler, a kid's module, a baby module, an infotainment module, a work module, and the like. Two or more of the floor consoles of the present invention may be used between different seating rows within a vehicle or at other locations in the vehicle. The add-on module is not designed to be placed over and existing console or structure on a seat of a vehicle.

U.S. Pat. No. 5,246,151 to Jabara discloses an organization device for use with a storage compartment of a vehicle. The organization device has a base member having legs which have notches or scoring for adjusting the length of the legs. The legs have removable mounting feet. The mounting feet are provided with suction cups to secure the base member within the storage compartment. The base member supports a tray having receptacles formed to transport specific items, such as tape cassettes, litter and beverages. The tray may be provided with removable and interchangeable receptacles. While the device 44 is designed to be placed within an existing compartment or console, it is not designed to be placed over and surrounding an existing console.

U.S. Pat. No. 3,804,233 to Gregg, Jr., discloses a multi-purpose article holding plastic tray which is readily applicable to and removable from atop an existing tunnel-hump in automobiles. The tray includes a horizontal top formed with a plurality of selectively usable well-like receivers providing open top holders, the top having a depending marginal supporting rim which, in turn, embodies smooth interior sidewalls joined by intervening transverse end walls. At least one of the holders is of a size and shape to receive one or more conventional tape cartridges. For best results the end walls of the stated holder are provided with interior inwardly projecting spaced parallel vertical main ribs. The ribs on one end wall are disposed and aligned with the main ribs on the other end wall in a manner to engage body surfaces of the tape cartridge and they seat and safely but accessibly locate the cartridges in readiness for use. These main ribs provide guideways for the cartridge or cartridges. The upper surface of the bottom wall is provided with a plurality of upstanding auxiliary ribs which constitute elevating rests atop which bottom surface portions of the tape cartridges reside, that is in a manner to minimize likelihood of sticking and interfering with ready removal for use. Weighted tray positioning and hold-down bags are provided with stick holding hems which are detachably and adjustably connected with median slotted portions of the respective sidewalls. The plastic tray is not designed to be placed over an existing console.

U.S. Pat. No. 4,915,275 to Brown discloses multi-purpose, adjustable stabilizing cleats which can be secured to various types of transmission and/or drive shaft tunnel or hump mounted trays with adjustment of the cleats enabling them to be positioned for engagement with surface areas of transmission humps or tunnels of different shapes and configurations. The cleats can also be attached to other objects for engaging carpeted surfaces, upholstered furniture, etc. The module is designed to be placed on the transmission tunnel of a vehicle and not placed over and existing console or structure on a seat of a vehicle.

U.S. Pat. No. 5,516,191 to McKee discloses a desk structure for use in association with vehicles, which is constructed to be positioned in place of the conventional swingable arm rest, or to be seated in a cavity formed in the typical arm rest or console. Means are provided for adjustably pivoting the desk structure into various positions, and for locking or securing the desk in the position selected. Cavities are provided in the desk structure for receiving a variety of accessories, exemplified by personal communication means such as a cellular telephone, pager, computer, and the like. The cavities and accessories are so positioned with respect to the vehicle driver as to permit their use without interference with or distraction from safe operation of the vehicle.

U.S. Design Pat. No. D434,720 Haack et al. discloses an ornamental design for an automotive console that is designed to fit over the transmission tunnel of a vehicle and not over and existing console on a seat of a vehicle.

### SUMMARY OF THE INVENTION

A device for use in conjunction with a console on a seat in a vehicle. The device enables an individual to maintain an office for business within a vehicle, such as a truck. The device includes a base unit which surrounds the console and is equipped with compartments, receptacles, writing surfaces and devices to support and retain electronic devices, such as lap top computers. The device includes a base unit. A plurality of writing surfaces and other compartments can be removable secured to the base unit. The writing surfaces can be provided with additional supports which are secured to the undersurface of the writing surface. The additional supports are designed to contact the seat of a vehicle and provide additional support for the writing surface. A compartment which is adapted to retain items such as cell phones, pagers and beverage vessels is releasably secured to a front of the base unit. A compartment which is adapted to retain items such as hanging files and beverage vessels is releasably secured to a rear of the base unit. A device to removably support an electronic device, such as a lap top computer, can be secured to the device. A strap extends from one of the sides of the base unit to the other side across the bottom of the base unit. The strap is used to help secure the device to a center console of a vehicle.

Accordingly, it is an objective of the present invention to provide a device which can be used in conjunction with a console on a seat of a vehicle to enable an individual to maintain an office to conduct business in a vehicle, such as a truck.

It is a further objective of the present invention to provide a device which surrounds an existing console, such as the center console, of a vehicle and provides compartments or cavities to hold and releasably retain items, such as cell phones, pagers, calculators, business brochures, work orders, etc.

It is yet another objective of the present invention to provide a device which can be used in conjunction with a console of a vehicle which provides compartments or cavities that are constructed and arranged to hold and releasably retain beverages vessels.

It is a still a further objective of the present invention to provide a device which can be used in conjunction with a console of a vehicle which includes a base and a plurality of members which are constructed and arranged to be releasably secured to the base.

It is a still a further objective of the present invention to provide a device which can be used in conjunction with a console of a vehicle which includes a base and a plurality of members which are releasably secured to a base without the use of separate fasteners.

It is a still a further objective of the present invention to provide a device which can be used in conjunction with a console of a vehicle which includes a hinged support member for a member releasably secured to a base.

It is a still a further objective of the present invention to provide a device which can be used in conjunction with a console of a vehicle which includes a support for an electronic device, such as a laptop computer.

It is a still further objective of the present invention to provide a device which can be used in conjunction with a console of a vehicle which enables the console to retain its original functions.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is an exploded view of the present invention illustrating different embodiments of a first member, different embodiments of a second member and different embodiments of a third member which are releasably secured to a base, also a device for supporting an electronic device is illustrated;

FIG. 2 is top, rear perspective view of a first embodiment of the present invention;

FIG. 3 is a top view of the embodiment of FIG. 2;

FIG. 4 is a bottom view of the embodiment of FIG. 2;

FIG. 5 is a front view of the embodiment of FIG. 2;

FIG. 6 is a right side view of the embodiment of FIG. 2;

FIG. 7 is a left side view of the embodiment of FIG. 2;

FIG. 8 is a rear view of the embodiment of FIG. 2;

FIG. 9 is a top, rear perspective view of a second embodiment of the present invention;

FIG. 10 is a bottom, front perspective view of the embodiment of FIG. 9;

FIG. 11 is a top view of the embodiment of FIG. 9;

FIG. 12 is a bottom view of the embodiment of FIG. 9;

FIG. 13 is a front view of the embodiment of FIG. 9;

FIG. 14 is a right side view of the embodiment of FIG. 9;

FIG. 15 is a rear view of the embodiment of FIG. 9;

FIG. 16 is a top, rear perspective view of a third embodiment of the present invention;

FIG. 17 is a bottom, front perspective view of the embodiment of FIG. 16;

FIG. 18 is a top view of the embodiment of FIG. 16;

FIG. 19 is a bottom view of the embodiment of FIG. 16;

FIG. 20 is a front view of the embodiment of FIG. 16;

FIG. 21 is a rear view of the embodiment of FIG. 16;

FIG. 22 is a right side view of the embodiment of FIG. 16; and

FIG. 23 is a left side view of the embodiment of FIG. 16.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

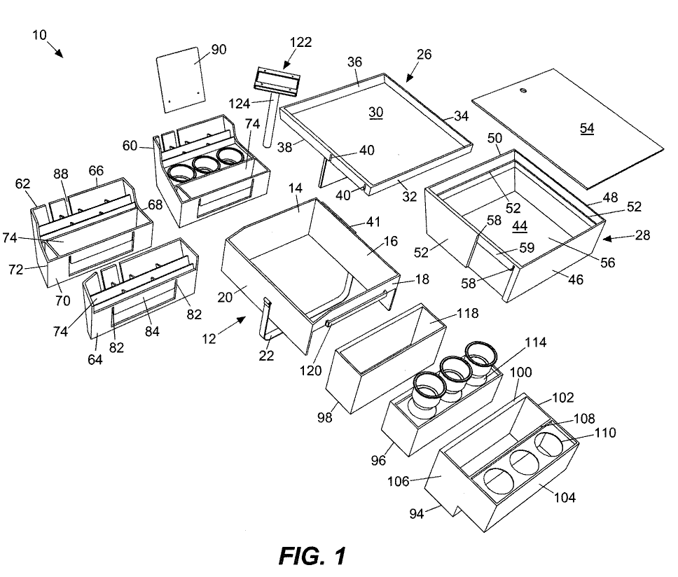

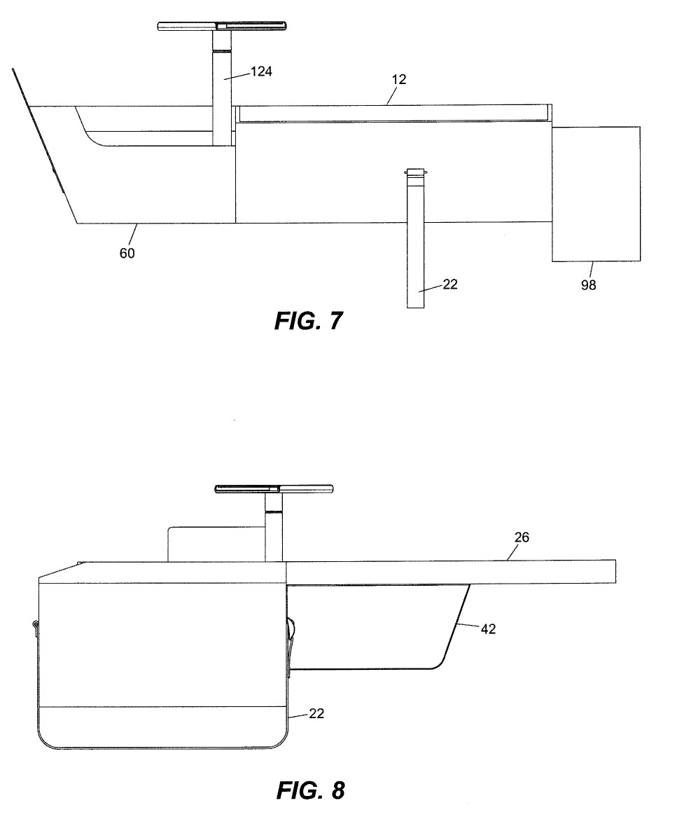

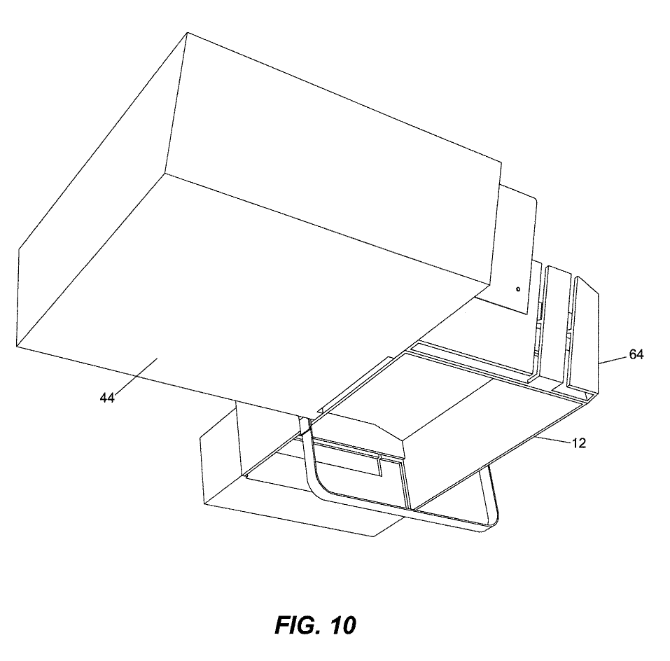

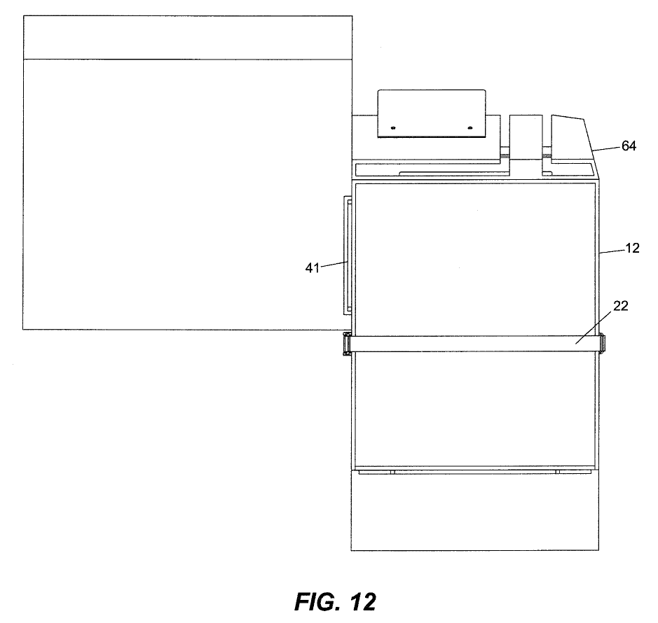

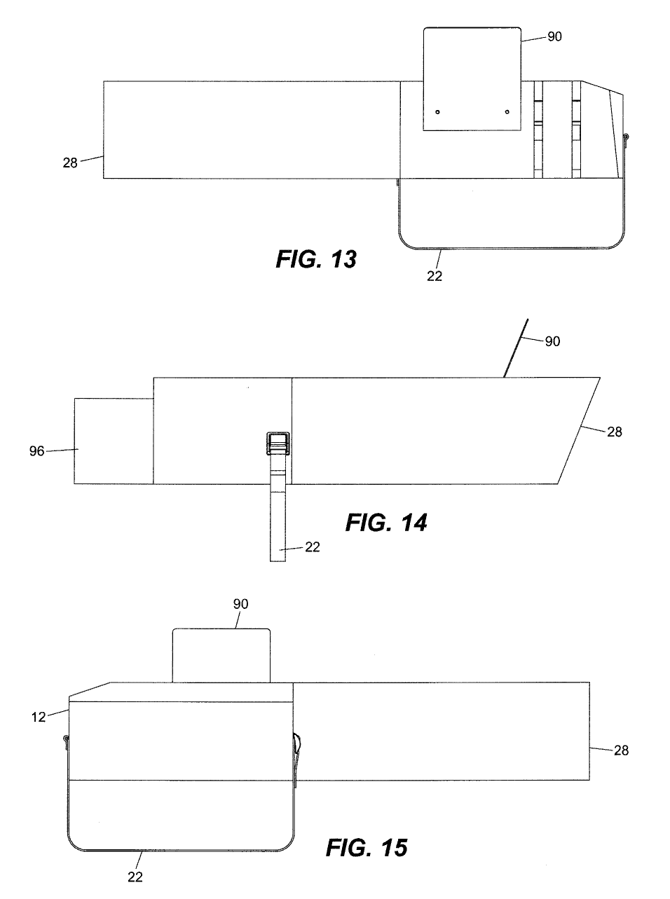

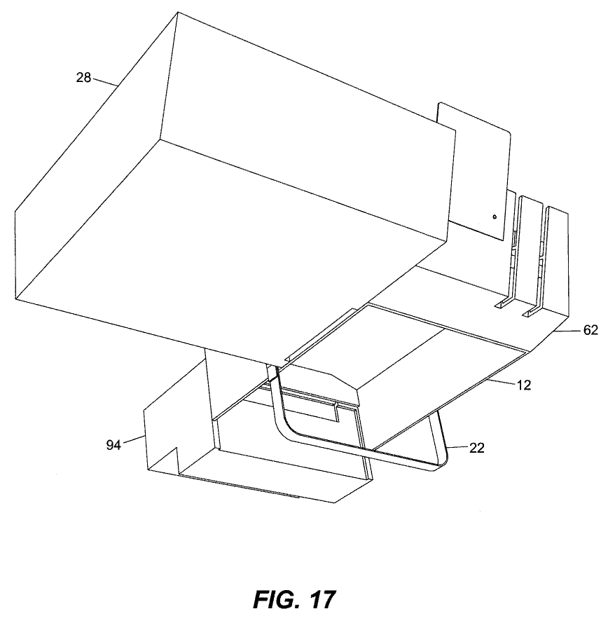

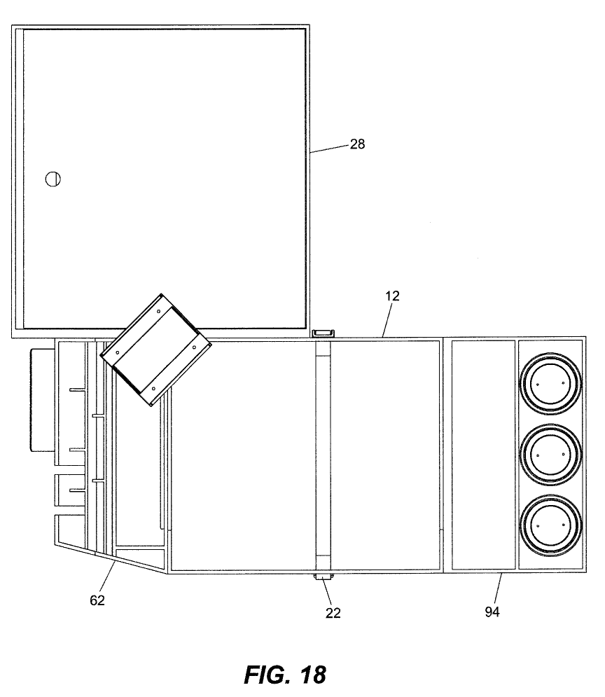

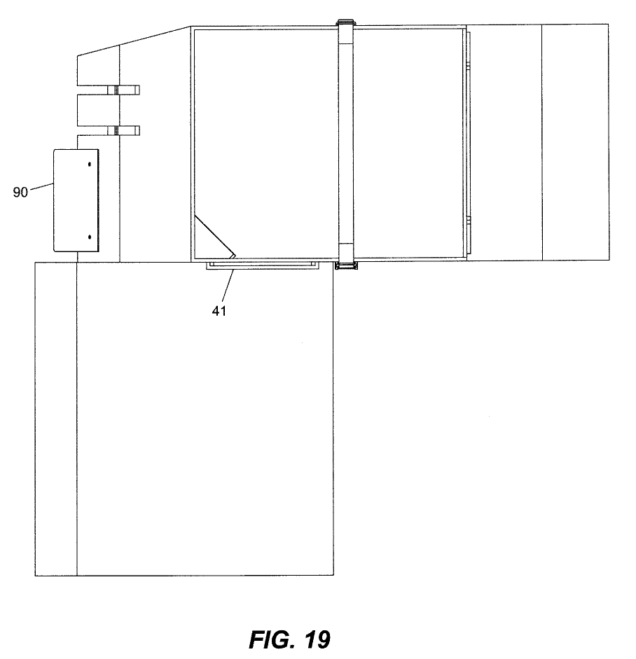

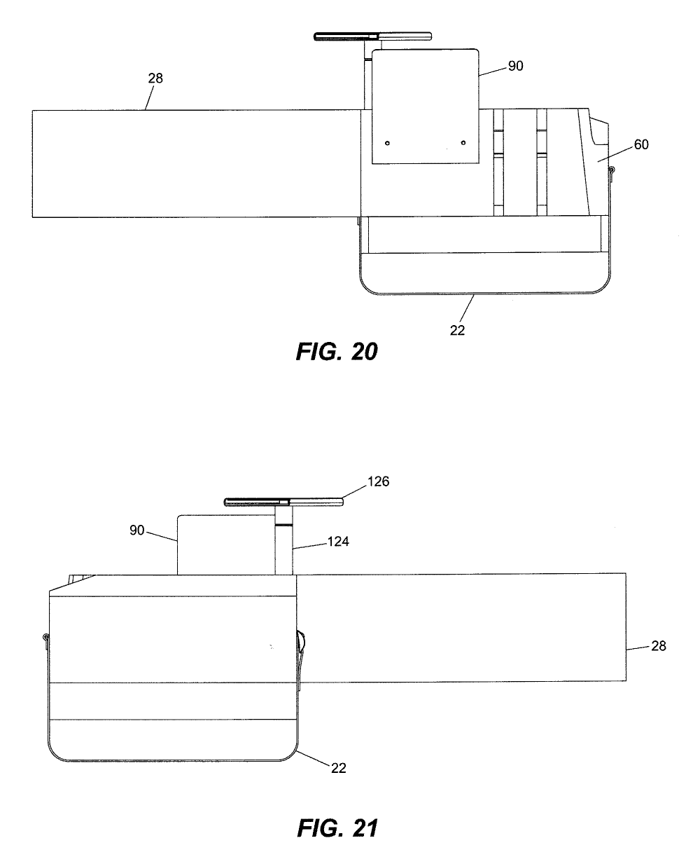

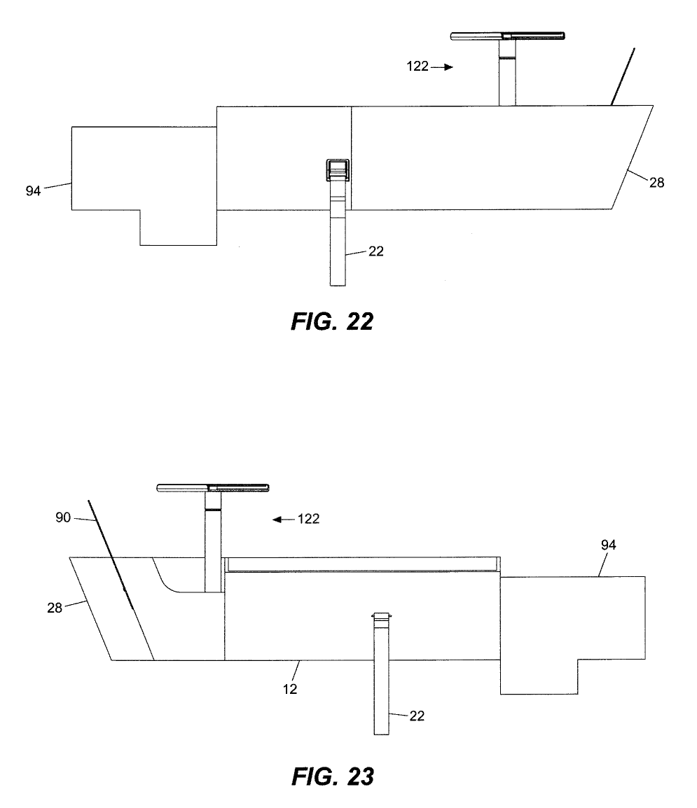

Referring now to FIGS. 1-23 of the drawings the present invention, including various different embodiments thereof, will be described. In FIG. 1 the vehicle console organizer of the present invention comprises a structure 10 which includes a base 12 and various members which can be removably secured to the base 12. The base is preferably formed from four walls. A front wall 14, a right side wall 16, a rear wall 18 and a left side wall 20. These walls are secured to each other at the end portions of the walls to form the base 12. As illustrated in FIG. 1 the base 12 is substantially square. However, base 12 can also be formed into any shape from any number of walls. Base 12 does not have a top or bottom so that it can readily be placed over and secured to a center console of a vehicle. Base 12 also includes a strap 22 which is secured to and extends from a left side 20 underneath the base and is secured to a right side 16 of the base. One end of the strap is secured to left side wall 20 and the other end of strap 22 is secured to right side wall 16 utilizing an adjustable cinch 24, FIG. 6. The strap enables the console organizer to be releasably secured to the center console of a vehicle. Many original equipment (OE) center consoles in a front seat of a vehicle pivot upwardly to provide an additional seat. Strap 22 passes around the lower portion of the OE center console and enables the console organizer to be releasably secured thereto.

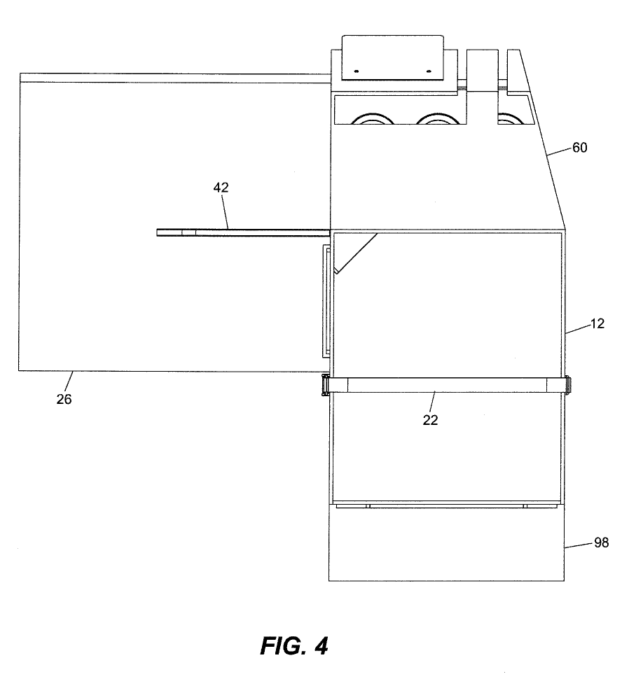

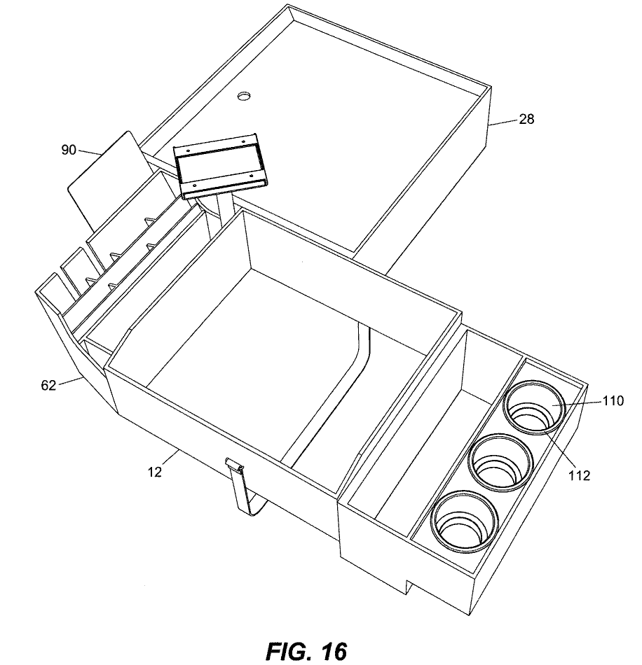

A first member is releasable secure to a right side wall of base 12. In FIG. 1 two embodiments of the first member are illustrated. A first embodiment 26 comprises a relatively flat surface. A second embodiment 28 comprises a relatively deep compartment or cavity. The first embodiment includes a relatively flat surface 30. While surface 30 is illustrated as square, it can be any other shape. A plurality of upstanding edges 32, 34, 36 and 38 surround the surface 30. The edges define the perimeter of the surface 30 and help to retain any articles that are placed on surface 30 from falling off of the surface. One of the edges 38 is provided with a plurality of grooves 40. These are used to releasably secure the first member to the base. A bar 41 is integrally formed onto right side wall 16 (FIGS. 1 and 16). Slots 40 are placed over and engage bar 41 thus supporting the first member 26. A support member 42 is secured to a lower portion of the first member and extends substantially vertically downwardly therefrom, FIGS. 4-6. The lower edge of the support member preferably rests on the seat of the vehicle and provides support for the first member so as enable surface 30 to retain items, provide a writing surface, etc. While support member 42 is illustrated as fixed to the first member, it can be hingedly secured and removably secured also.

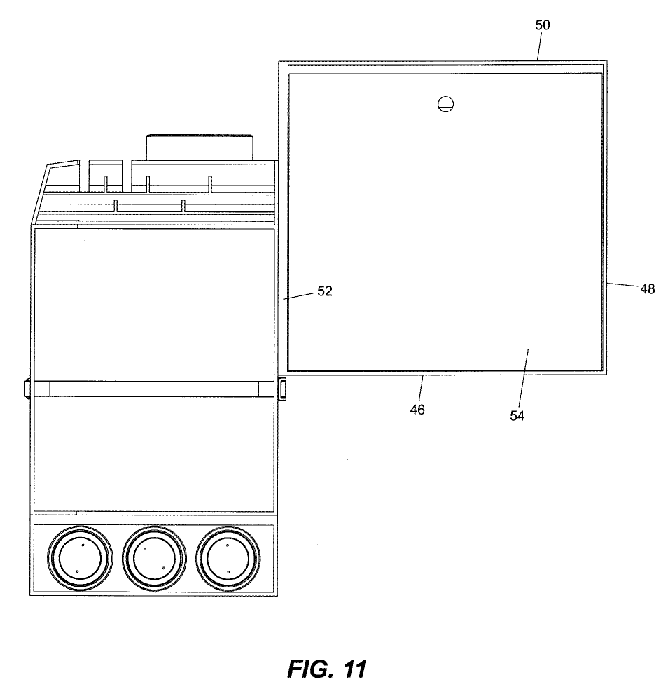

A second embodiment 28 of the first member includes a relatively flat bottom 44. Four substantially vertically upstanding walls 46, 48, 50 and 52 (FIG. 11) are connected to the bottom 44 and form a compartment or cavity. Various items can be stored or retained within the cavity. Each of the walls also includes a ridge 52 located on an inner surface of the walls. The ridges 52 are aligned in a horizontal plane and provide a support for a cover 54. Cover 54 is placed on the ridges and is thus removably secured to the top portion of the compartment or cavity 56. Cover 54 encloses the compartment or cavity and also provides a relatively flat surface to hold items or as a surface for writing. While cover 54 is illustrated as completely removable from the first member, it can also be hingedly attached or secure thereto by other means. Upstanding wall 52 is provided with a plurality of slots 58 and a tab 59. Slots 58 and tab 59 engage bar 41 in the same manner as slots 40 and provide support for the first member 28.

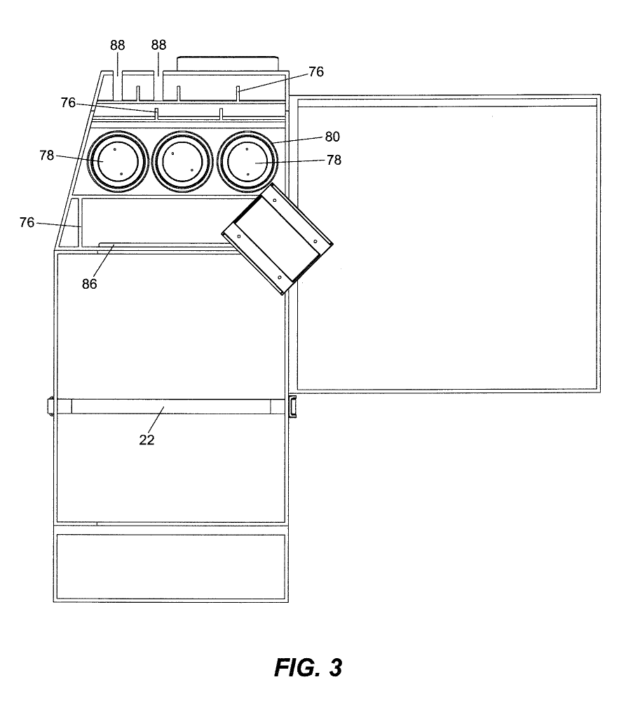

A second member is releasably secured to a front of base 12. The second member includes at least three embodiments 60, 62 and 64, illustrated in FIG. 1. Each of these embodiments includes a front wall 66, a right side wall 68, a rear wall 70 and a left side wall 72. Each of the embodiments of the second member further includes at least one interior wall 74. The interior walls 74 extend from a right side wall 68 to a left side wall 72 and from a bottom toward a top portion of the second member. The interior walls are substantially vertical and substantially parallel to the rear wall 70. Each of the second members can also include transverse interior walls 76 (FIG. 3). These transverse interior walls can extend between the front wall 66 and an interior wall 74. They can extend between interior walls. They can also extend between an interior wall and the rear wall 64. The transverse interior walls cooperate with the interior walls, the front and rear wall to divide the interior of second member into a plurality of compartments or cavities.

The second member can also be provided with a plurality cavities 78 (FIG. 3) which are constructed and arranged to releasably retain a beverage vessel or container. While the cavities 78 are illustrated as circular they can be any other shape. The shape of the cavity 78 will normally be determined by the shape of the beverage vessel. While three cavities are illustrated, any number of cavities can be employed. The cavities can further be provided with a removable liner 80. Liner 80 is constructed and arranged to releasably retain a beverage vessel or container. Liner 80 is preferably readily removably from cavity 78, but can be permanently secured thereto.

The rear wall 70 of all of the embodiments of the second member is provided with a plurality of slots 82 and a tab 84. The front wall 14 of the base 12 is provided with a bar 86 integrally formed thereon toward a top portion (FIG. 3). Slots 82 and tab 84 cooperatively engage bar 86 to releasably support a second member on the front wall of the base.

In the preferred embodiments of the second member the left side wall 72 is not parallel to the right side wall. The left side wall is angled inwardly toward the center of the second member. This construction enables the individual on the left side of the console organizer, usually the driver of the vehicle, to have ready access to items in the vehicle on the dashboard and in the front of the console organizer. While this construction is preferred the left and right side walls could also be substantially parallel to each other. The front wall 66 of the second member is preferably provided with at least one vertically extending slot 88 (FIGS. 1-3). These slots in conjunction with the front wall 66 of the second member can be used to releasably retain various items. While the slots are preferably illustrated and extending the entire height of the front wall 66, they could also extend only a portion of the height of the front wall and therefore not completely extend from the bottom to the top of the front wall 66.

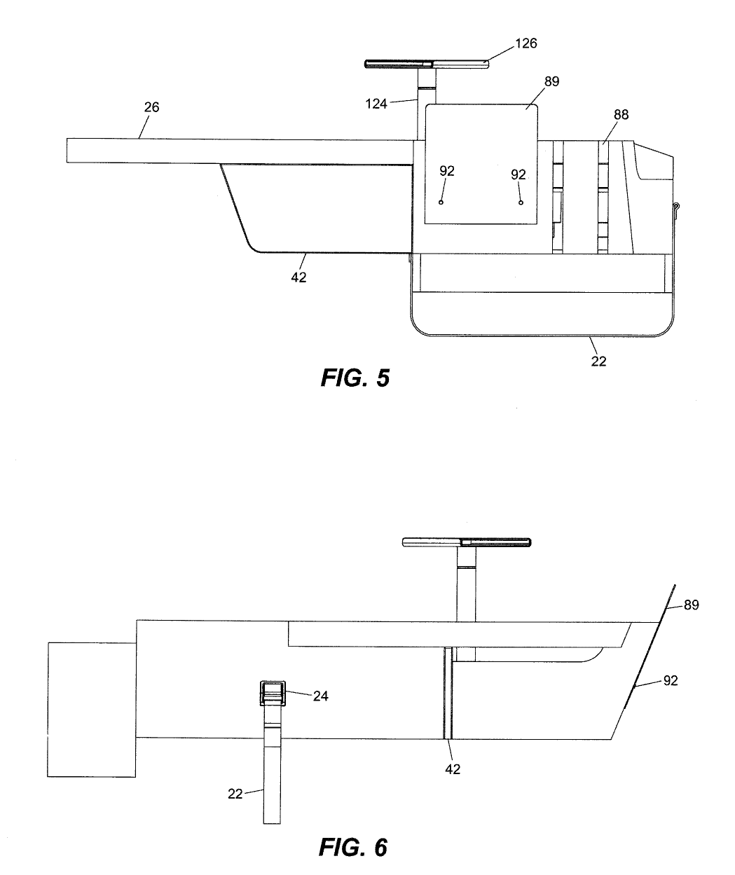

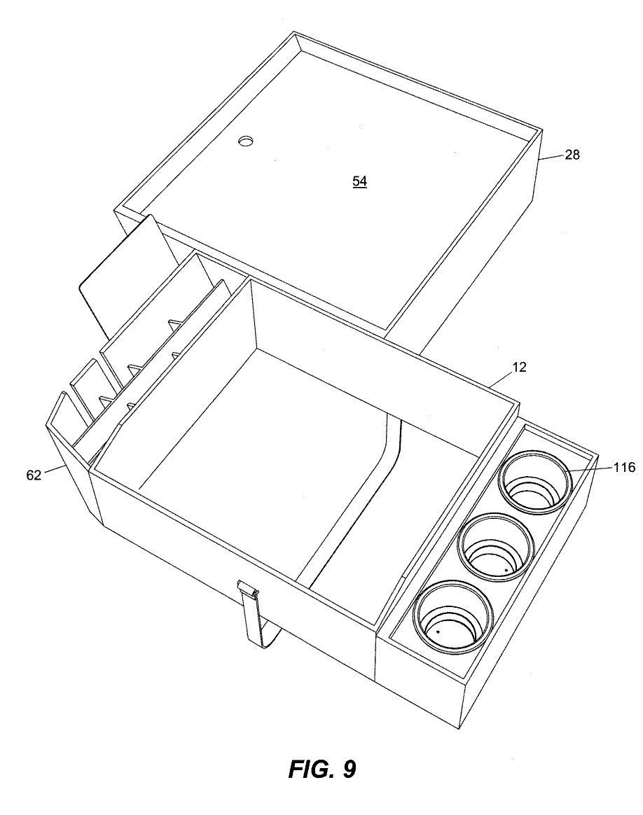

The front wall 66 of the second member can also be provided with an element 90. Element 90 is secured to the front wall 66 by means of fasteners 92 (FIG. 5). Element 90 extends parallel to and above the top of the front wall 66, as illustrated in FIG. 6. Various items can be releasably secured onto element 90. While preferably illustrated as parallel to the front wall 66, element 90 can be secured to the front wall 66 at an angle thereto. A third member is releasably secured to a rear of base 12. The third member includes at least three embodiments 94, 96 and 98, illustrated in FIG. 1. Each of these embodiments includes a front wall 100, a right side wall 102, a rear wall 104 and a left side wall 106. The third member can be the same height and the base 12, as illustrated in FIG. 9 or a different height than base 12, as illustrated in FIGS. 14, 16, 17, 22 and 23.

A first embodiment 94 of the third member includes an interior wall 108 which divides the third member into two compartments or cavities. The wall 108 is substantially parallel to the front and rear walls 100, 104. The interior wall 108 has the same height or vertical dimension as front wall 100, as seen in FIG. 1. The compartment or cavity of the third member is constructed and arranged to releasably hold items. Some of the items that can be placed and retained with in this compartment are hanging files. This compartment may or may not have a bottom wall. The other compartment or cavity of embodiment 94 can also be provided with a plurality cavities 110 (FIG. 16) which are constructed and arranged to releasably retain a beverage vessel or container. While the cavities 110 are illustrated as circular they can be any other shape. The shape of the cavity 110 will normally be determined by the shape of the beverage vessel. While three cavities are illustrated, any number of cavities can be employed. The cavities can further be provided with a removable liner 112 (FIG. 16). Liner 112 is constructed and arranged to releasably retain a beverage vessel or container. Liner 112 is preferably readily removably from cavity 110, but can be permanently secured thereto.

A second embodiment 96 of the third member can also be provided with a plurality cavities 114 which are constructed and arranged to releasably retain a beverage vessel or container. While the cavities 114 are illustrated as circular they can be any other shape. The shape of the cavity 110 will normally be determined by the shape of the beverage vessel. While three cavities are illustrated, any number of cavities can be employed. The cavities can further be provided with a removable liner 116 (FIG. 9). Liner 116 is constructed and arranged to releasably retain a beverage vessel or container. Liner 116 is preferably readily removably from cavity 114, but can be permanently secured thereto. While the second embodiment 96 is illustrated as preferably being the same height as base 12, it could also be any other height.

A third embodiment of the third member 98 includes a single compartment or cavity 118. Compartment or cavity is constructed and arranged to releasably retain items. Some of the items that can be placed and retained with in compartment 118 are hanging files. While the third embodiment 98 is illustrated as preferably being a greater height than base 12, it could also be the same height or any other height.

The front wall 100 of all of the embodiments of the third member is provided with a plurality of slots and a tab not shown. The rear wall 18 of the base 12 is provided with a bar 120 integrally formed thereon toward a top portion (FIG. 1). The slots and a tab on the front wall of the third member cooperatively engage bar 120 to releasably support the third member on the rear wall of the base 12.

While the first, second and third members have been illustrated and being removably secured to the base 12 by utilizing slots and a tab on the members and a bar on the base, these elements can also be reversed. The bar can be positioned on the first, second and third member and the slots and tab can be positioned on the base 12. In addition any other means to secure the member s to the base can be employed, including means to permanently secure the elements together.

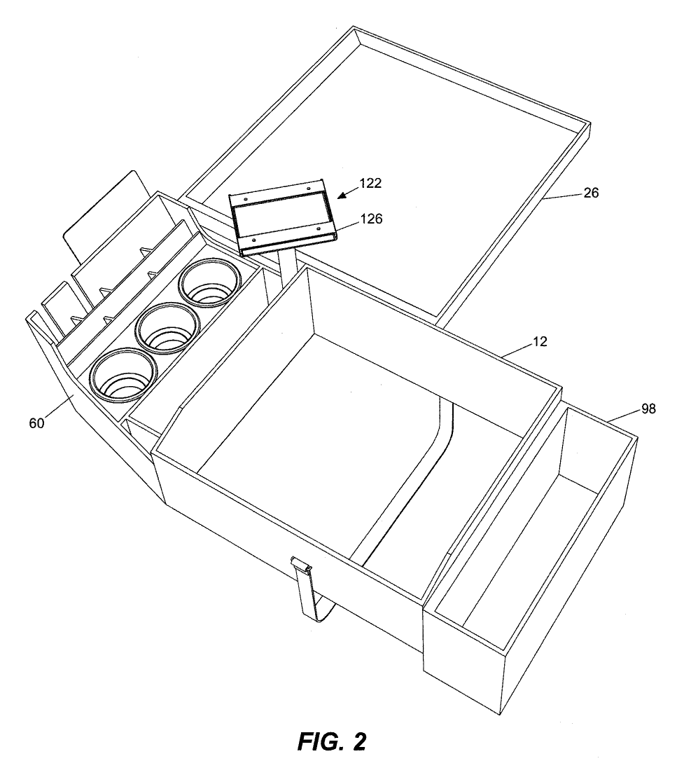

A substantially vertically extending member 122 is secured to the second member, as illustrated in FIG. 2. The vertically extending member 122 includes a post or support 124 which is secured to the second member at a lower portion of the post 124. An electronic device support element 126 is secured to the top of post 124 (FIG. 5). Preferably support element 126 is pivotally secured to the top of post 124. However, support element 126 can be secured in any manner to the top or top portion of post 124. An electronic device, such as a laptop computer, not shown, is placed upon element 126 supported by post 124 in a position to enable an individual in the vehicle to gain ready access and use the electronic device.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A structure for mounting on a seat in a vehicle operated by an individual comprising:
a base constructed and arranged to substantially surround a console mounted on said seat, said base including at least one first portion open at a top and a bottom thereof and providing a passageway vertically thorough said structure, said base having a front, sides, a rear, a top and a bottom;
at least one first member constructed and arranged to be releasably secured to one of said sides of said base;
at least one second member constructed and arranged to be releasably secured to said front of said base, said at least one second member including at least one cavity constructed and arranged to retain items;
at least one third member constructed and arranged to be releasably secured to said rear of said base, said at least one third member including at least one cavity constructed and arranged to retain items; and
said structure including a device constructed and arranged to releasably support an electronic device.

2. The structure of claim 1 wherein said at least one first portion of said base includes a plurality of substantially vertically extending walls connected together and forming said passageway.

3. The structure of claim 1 wherein said at least one first member is releasably secured to said base without the use of separate fasteners, said separate fasteners are also not integrally formed into said base and into said at least one first member.

4. The structure of claim 3 wherein said at least one first member includes a substantially flat surface, a plurality of edges, said edges being substantially higher in a vertical dimension that said flat surface, one of said edges includes a device securing said at least one first member to said base.

5. The structure of claim 4 wherein said at least one first member includes a support member extending substantially vertically downwardly from a bottom of said at least one first member.

6. The structure of claim 4 wherein said base includes a substantially horizontal bar integrally formed in at least one of said sides of said base, said at least one first member includes a plurality of slots integrally formed in one of said edges of said at least one first member, said slots cooperatively engaging said bar and releasably connecting said at least one first member to said base.

7. The structure of claim 3 wherein said at least one first member includes a substantially flat bottom, a plurality of substantially vertically walls connected to said bottom and extending upwardly from said bottom, said walls being connected to each other at end portions thereof, one of said walls including a device securing said at least one first member to said base.

8. The structure of claim 7 wherein said at least one first member includes a ridge formed on an inside of each of said walls, said ridge providing a surface supporting a cover, said cover extending in a substantially horizontal plane over substantially the entire vertical cross section of said at least first member, said cover being spaced from said bottom and forming a substantially enclosed cavity with said walls and said bottom.

9. The structure of claim 7 wherein said base includes a substantially horizontal bar integrally formed in at least one of said sides of said base, said at least one first member includes a plurality of slots integrally formed in one of said edges of said at least one first member, said slots cooperatively engaging said bar and releasably connecting said at least one first member to said base.

10. The structure of claim 1 wherein said at least one second member is releasably secured to said base without the use of separate fasteners, said separate fasteners are also not integrally formed into said base and into said at least one first member.

11. The structure of claim 10 wherein said at least one second member includes a front wall, a rear wall and a plurality of cavities constructed and arranged to releasably hold and retain items positioned in between said front and said rear walls.

12. The structure of claim 11 wherein said at least one second member includes at least one substantially vertically extending slot in said front wall.

13. The structure of claim 11 wherein said at least one second member includes at least one cavity constructed and arranged to releasably retain a beverage vessel.

14. The structure of claim 11 wherein said base includes a substantially horizontal bar integrally formed in said front of said base, said at least one second member includes a plurality of slots integrally formed in said rear wall of said at least one second member, said slots cooperatively engaging said bar and releasably connecting said at least one second member to said base.

15. The structure of claim 11 wherein said at least one second member includes at least one wall positioned in between said front wall and said rear wall and extending in substantially the same vertical plane as said front wall and said rear wall.

16. The structure of claim 11 including an element extending substantially parallel to and secured to said front wall of said at least one second element, said element extending vertically upward above a top of said at least one second member.

17. The structure of claim 11 wherein said front wall of said at least one second member is shorter in length than said rear wall of said at least one second member, a side wall of said at least one second member extending between said front wall and said rear wall at an angle with respect to a vertical longitudinal plane of said structure.

18. The structure of claim 1 wherein said at least one third member is releasably secured to said base without the use of separate fasteners, said separate fasteners are also not integrally formed into said base and into said at least one first member.

19. The structure of claim 18 wherein said at least one third member includes a front wall, side walls, a rear wall and at least one cavity constructed and arranged to releasably hold and retain items positioned in between said front, said side and said rear walls.

20. The structure of claim 18 wherein said at least one third member includes at least one cavity constructed and arranged to releasably retain a beverage vessel.

21. The structure of claim 18 wherein said base includes a substantially horizontal bar integrally formed in said rear of said base, said at least one third member includes a plurality of slots integrally formed in said front wall, said slots cooperatively engaging said bar and releasably connecting said at least one third member to said base.

22. The structure of claim 18 wherein said at least one third member includes at least two cavities, said cavities having different vertical dimensions.

23. The structure of claim 1 including a strap secured to at least two of said walls of said base and extending between said walls below said bottom of said base whereby said structure can be secured to a console mounted on a seat of a vehicle utilizing said strap.

24. The structure of claim 1 wherein said device includes a vertically extending member secured at one end to said at lease one second member, said device including an electronic device support member secured to an opposite end, said electronic device support being constructed and arranged to releasably support an electronic device in an operating position.
